(19) United States
(12) Patent Application Publication
(10) Pub. No.: US 2016/0283866 A1
(43) Pub. Date: Sep. 29, 2016

(54) COMPUTER-IMPLEMENTED METHOD AND SYSTEM FOR OPTIMIZING TRAVEL SPECIFICATIONS USING MATHEMATICAL COMBINATIONS

(71) Applicant: Jeffrey David HASSELO, Mountain View, CA (US)

(72) Inventor: Jeffrey David HASSELO, Mountain View, CA (US)

(21) Appl. No.: 14/940,149

(22) Filed: Nov. 13, 2015

Related U.S. Application Data
(60) Provisional application No. 62/138,965, filed on Mar. 26, 2015.

(51) Int. Cl. G06Q 10/02; G06Q 50/14

(52) U.S. Cl. CPC G06Q 10/02; G06Q 50/14

(57) ABSTRACT

A computer-implemented method and system for optimizing travel specifications using mathematical combinations. The method includes receiving a range of specifications for a desired trip from a user. The specifications comprises of number of travelers, departure city, potential cities to visit, specific dates of the trip, duration ranges of stay at each city, hotel requirements and transportation options. Further, the method includes calculating a plurality of mathematical combinations based on the specifications to yield best potential itinerary options for the trip. Furthermore, the method includes presenting a list of the best potential itinerary options to the user along with the amount saved for each itinerary option.

### TECHNICAL FIELD

Embodiments of the disclosure relate generally to travel industry. Embodiments relate more particularly to a computer-implemented method and system to optimize travel specifications using mathematical combinations.

### BACKGROUND

Numerous people travel between geographical locations by a desired mode of transport, such as car, train, boat and airplane. Generally, the travel includes relatively short stays between successive geographical locations. Travelers are often inspired to learn and discover through the journey. Further, travelling allows people to take up challenges to plan an amazing trip that would linger in their memories.

Today, travel may not be very easy to plan due to various travel decisions, such as choosing destination place, modes of transport, hotels and cities to visit. Particularly, overseas travel is expensive. Unfortunately, 82% of travelers eventually pay the full amount. A substantial aspect while taking travel decisions is the cost involved in the trip. Another vital aspect of travelling decisions is the time taken to plan an itinerary (a detailed plan for a journey, especially a list of places to visit). The travelers spend considerable amount of time in researching, planning and booking an itinerary that satisfies all the travelers. Typically, a personal experience planning for a multi-city itinerary is a 3-5 days process at a minimum.

Further, combining various travel decisions remains a challenge to the travelers. As the number of cities and options (date ranges, hotels, flights and trains) increases, the number of potential combinations grows exponentially. Consequently, the exponential growth makes it merely impossible and cost ineffective for the traveler to calculate an optimal itinerary by themselves.

Several existing techniques, for example Expedia and Kayak, attempt to overcome the cost and time pain points of travelers. However, the travelers are only allowed to choose specific dates to travel to each city and receive price quotes for each flight to each city with no hotel options. Moreover, the existing techniques do not offer an ability to optimize a trip based on the traveler specifications.

In the light of the above discussion, there appears to be a need for planning a trip much easier in terms of cost, time and convenience.

### OBJECT OF INVENTION

The principal object of the embodiments herein is to provide a computer-implemented method for optimizing a trip using mathematical combinations to identify the best itinerary.

Another object of the embodiments herein is to reduce the amount of time required to plan the best itinerary and manage all costs of the trip efficiently.

### SUMMARY

The above-mentioned needs are met by a computer-implemented method, computer program product and system for optimizing travel specifications using mathematical combinations.

An example of a computer-implemented method for optimizing travel specifications using mathematical combinations includes receiving a range of specifications for a desired trip from a user. The specifications comprises of number of travelers, departure city, potential cities to visit, range of dates of the trip, duration ranges of stay at each city, hotel requirements and transportation options. Further, the computer-implemented method includes calculating a plurality of mathematical combinations based on all the specifications to yield best potential itinerary options for the trip. Furthermore, the computer-implemented method includes presenting a list of the best potential itinerary options to the user along with the amount saved for each itinerary option.

An example of a computer-program product for optimizing travel specifications using mathematical combinations includes receiving a range of specifications for a desired trip from a user. The specifications comprises of number of travelers, departure city, potential cities to visit, range of dates of the trip, duration ranges of stay at each city, hotel requirements and transportation options. Further, the computer-program product includes calculating a plurality of mathematical combinations based on all the specifications to yield best potential itinerary options for the trip. Furthermore, the computer-program product includes presenting a list of the best potential itinerary options to the user along with the amount saved for each itinerary option.

An example of a system for optimizing travel specifications using mathematical combinations includes a client device operated by a user. Further, the system includes a centralized database to store pricing data for specifications of a trip. Furthermore, the system includes a processor coupled within the computing device and configured to perform the method of optimizing travel specifications:

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE VIEWS OF DRAWINGS

In the accompanying figures, similar reference numerals may refer to identical or functionally similar elements. These reference numerals are used in the detailed description to illustrate various embodiments and to explain various aspects and advantages of the present disclosure.

FIG. 1 is a block diagram of the environment, according to the embodiments as disclosed herein;

FIG. 2 is a flow chart describing a method for optimizing travel specifications using mathematical combinations, according to the embodiments as disclosed herein;

FIG. 3a and FIG. 3b are exemplary representations illustrating different combinations for a trip, trip costs and best itinerary, according to the embodiments as disclosed herein; and

FIG. 4 is a block diagram of a machine in the example form of a computer system within which instructions for causing the machine to perform any one or more of the methodologies discussed herein may be executed.

### DETAILED DESCRIPTION OF THE EMBODIMENTS

The above-mentioned needs are met by a computer-implemented method and system for optimizing travel specifications using mathematical combinations. The following detailed description is intended to provide example implementations to one of ordinary skill in the art, and is not intended to limit the invention to the explicit disclosure, as one or ordinary skill in the art will understand that variations can be substituted that are within the scope of the invention as described.

### Environment Block Diagram

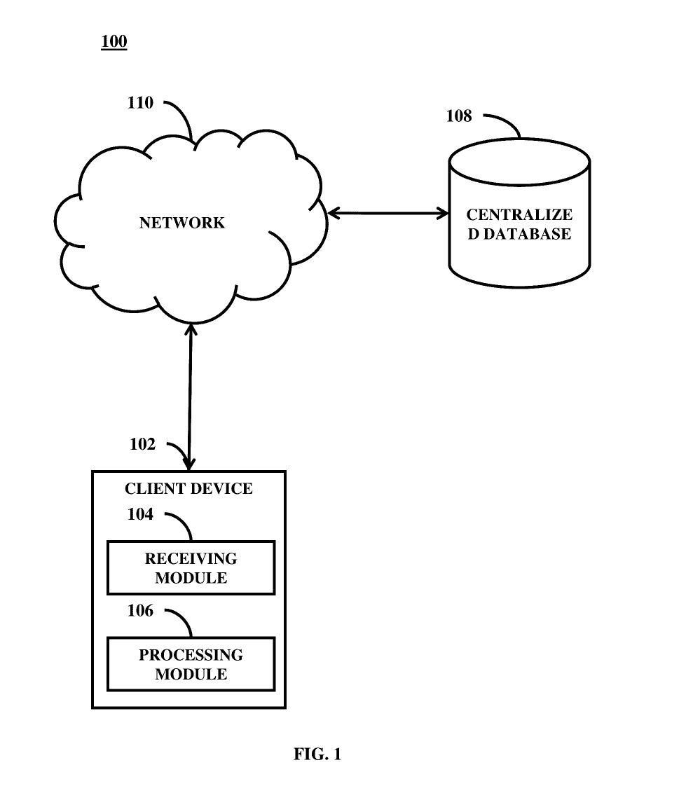

FIG. 1 is a block diagram of the environment, according to the embodiments as disclosed herein. The environment 100 includes a client device 102, a centralized database 108 and a network 110.

Typically, the client device 102 is a portable computing device. Examples of the client device 102 include, but are not limited to, a personal computer (PC), laptops, a mobile phone, a tablet device, a personal digital assistant (PDA), a smart phone and a laptop. The client device 102 includes a receiving module 104 and a processing module 106. The receiving module 104 receives travel specifications from the user (traveller/customer) of the client device 102. Examples of the travel specifications include, but are not limited to, departure city, desired cities to visit, duration of stay at each city and hotels. The processing module 106 is configured with a calculation engine (not shown in FIG. 1) to calculate the best itinerary using mathematical combinations for the received travel specifications. It should be appreciated by those of ordinary skill in the art that FIG. 1 depicts the client device 102 in an oversimplified manner, and a practical embodiment may include additional components and suitably configured processing logic to support known or conventional operating features that are not described in detail herein.

The processing module 106 is configured with a non-transitory computer-readable medium, the contents of which causes the client device 102 to perform the method disclosed herein.

The network 108, for example, the Internet, allows the client device 102 to connect to Application Programming Interfaces (API's) of several travel agencies, such as, Expedia Affiliate Network, ITA Software, Kayak, AirBnB, Orbitz and TripAdvisor. Subsequently, the client device 102 retrieves pricing data from the travel site and provides and stores it in the centralized database 108. The pricing data is later used to perform calculations using mathematical combinations.

A user of the client device 102 inputs travel specifications or ranges for a desired trip. Generally, the user is a person who travels to multiple cities for a specific purpose (for example, educational trip, vacation, visiting friends, and business trip). The travel specifications are absolute values and sliders of ranges between the cost of the trip and convenience. Typically, the travel specifications define specific variables of the trip. Examples of the variables include, but are not limited to, flights, dates, hotels and cities.

Consequently, several potential itineraries are optimized using mathematical combinations of the travel specifications. The potential itineraries solve time, convenience, and cost factors for the trip. Consequently, the user is presented with a list of various itineraries and the amount of money saved in each of the itinerary. The list includes the best (cheapest) itinerary option for the trip.

### Operational Flow Chart

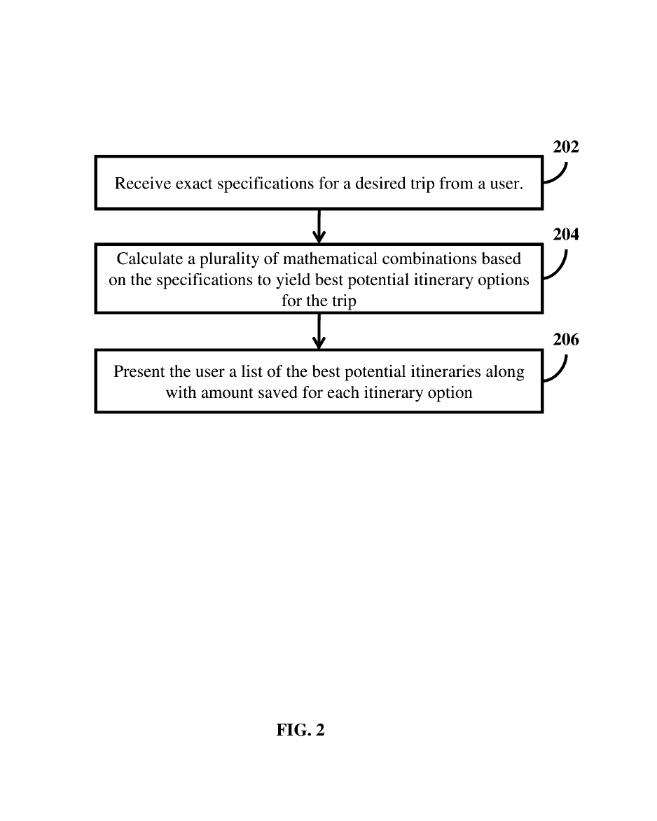

FIG. 2 is a flow chart describing a method for optimizing travel specifications using mathematical combinations, according to the embodiments as disclosed herein. The flow chart begins at step 202.

At step 202, the exact specifications are received for a desired trip from a user (a traveler or a customer). The exact specifications are absolute values of various variables. Further, sliders for ranges between cost of the trip and convenience (for example, a morning flight) are also received from the user.
a. The variables include, but are not limited to the following:
b. Departure City
c. Specific dates of the trip or preferred month of travelling
d. Cities desired to visit along with the number of days or ranges desired to stay in each city
e. Hotel requirements (stars, location and so on) or specific hotels
f. Transportation options between the cities (air, bus, train, rental cars and so on).
g. Preferences such as seating, airlines and time ranges to travel.

At step 204, a plurality of mathematical combinations are calculated based on all the travel specifications to yield best potential itinerary options for the trip. Generally, the mathematical combinations are all possible arrangements of a collection of things or a set of variables. The arrangements are presented as a mathematical formula as n!, where “n” represents the number of variables. For example, for a three set variable “abc”, the combinations are as follows:

abc, acb, bac, bca, cab, cba

The present invention takes the concept of the mathematical combinations and applies it to planning a trip itinerary for a given set of variables.

To perform the mathematical combinations, pricing data for the travel variables (such as, hotels, cars, rentals, hotels and packages) are required. In a preferred embodiment, the pricing data can be retrieved through open API's from travel agencies (for example, Expedia, Priceline and Kayak), data providers (for example, ITA software owned by Google) and airlines. For example, Expedia provides an open API (Expedia Affiliate Network). The pricing data is stored in the centralized database (as described in FIG. 1) and subsequently used to perform the mathematical combinations. In some embodiments, the pricing data may be retrieved by “web scraping”. Web scraping (web harvesting or web data extraction) is a computer software technique used to extract information from websites. For example, Intuit scrapes all of the financial transaction data from bank websites and consolidates the data in customer's accounts.

Typically, the mathematical combinations are created by rearranging unique discrete variables of the trip. The variables can include, order of visiting cities, date ranges for the trip, multiple hotel options in a particular city, transportation options (train, flight, bus), requirement for a rental car in specific cities and number of days in each city. Further, the number of mathematical combinations increases exponentially with the number of variables. For example, consider a trip to Europe with multiple cities. The cities are four different variables (a, b, c and d) for which 24 different combinations (4×3×2×1) are calculated and shown as below:
abcd, abdc, acbd, acdb
bacd, badc, bcad, bcda,
cabd, cadb, cbad, cbda,
dabc, dacb, dcab, dcba

Further, the number of combinations grows exponentially with the number of variables. For example, consider a traveler who wants to visit 3 cities and opts for 5 different hotel options in each city. The 5 hotels act as a multiplier to the number of possible itineraries. Consequently, the number of possible itinerary combinations is:

3!=3×2×1=6×5×5×5=750 possible itineraries.

Referring to FIG. 1, the non-transitory computer-readable medium obtains the travel specifications and calculates several potential itineraries using mathematical combinations. The potential itineraries optimize cost, time and convenience to the user.

At step 206, the user is presented a list of the best potential itineraries (optimized itineraries) along with the amount of money saved for each itinerary option. The best itinerary is calculated by taking all the mathematical combinations of the variables and presenting the lowest price (travel cost) to the user. The user is also presented with the worst combination trip itinerary and the average trip itinerary combination along with corresponding costs. As a result, the user is shown the amount of money saved by optimizing the trip.

In addition to the list, the user is presented with the following:
a. Optimal dates to book the travel
b. Price alerts for the trip
c. Sightseeing recommendations
d. Travel Package Options

The flow chart ends at step 206.

As a result, the optimized itinerary is presented to the user. The user may now purchase the itinerary (flight, hotel and so on) through online travel agencies (such as, Expedia, Priceline, Kayak and so on).

The method described herein can be used by any consumer or business looking to save money in planning a trip. Further, the method is beneficial as the time taken to plan a trip is reduced. Moreover, the method aims to significantly reduce the travelling cost. In a specific embodiment, the method saves 15-30% of the total cost of the trip by optimizing the itinerary.

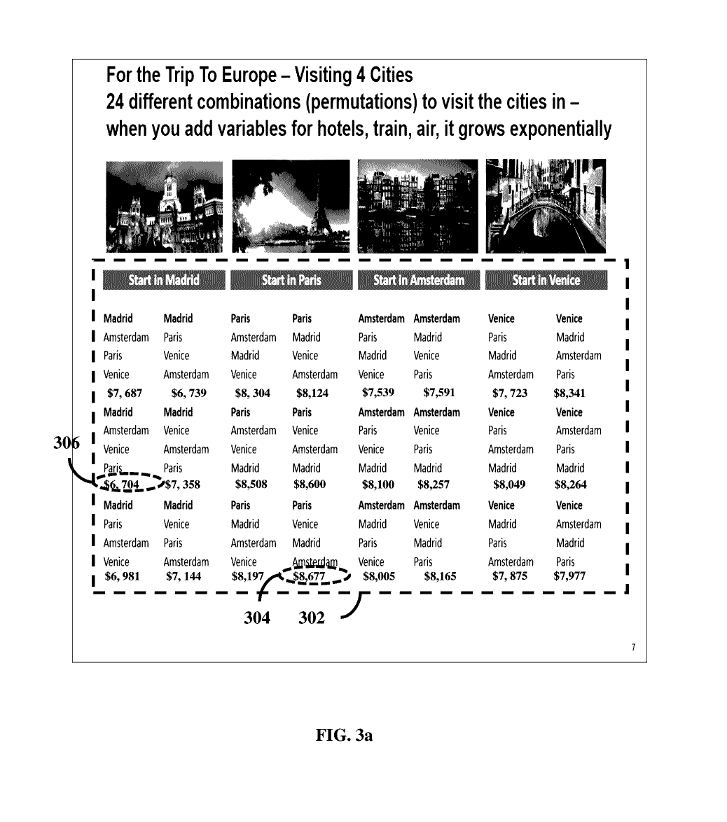

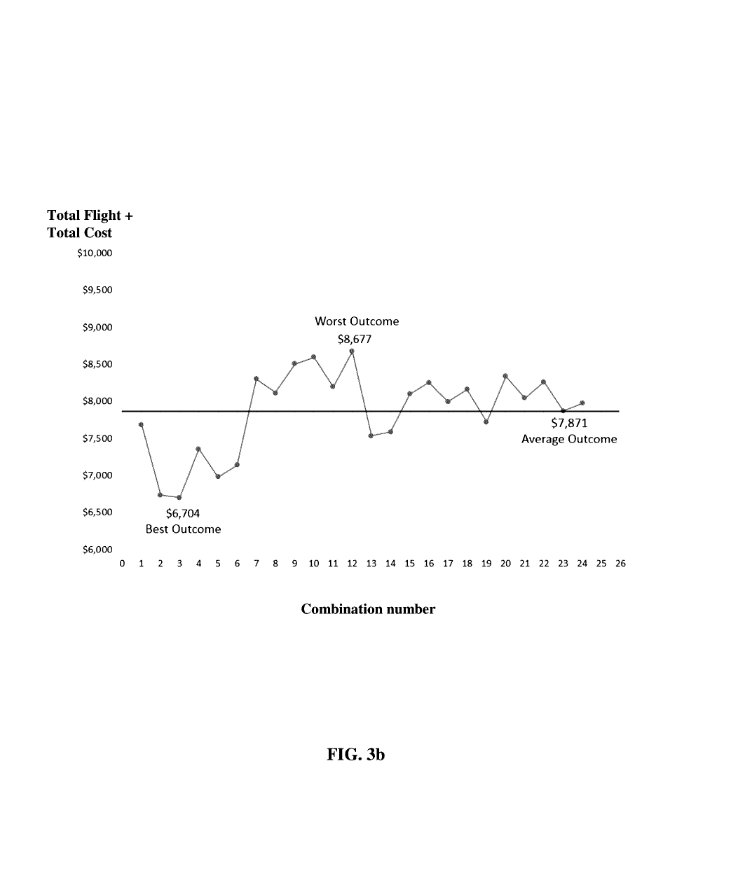

FIG. 3a and FIG. 3b are exemplary representations illustrating different combinations for a trip, trip costs and best itinerary, according to the embodiments as disclosed herein.

### Exemplary Representation

FIG. 3a is an exemplary representation of a trip to Europe, visiting four cities. The four cities are Madrid, Paris, Amsterdam and Venice. Mathematical combinations on the four cities yield 24 different combinations 302 to visit the cities. Each city is considered as the start venue and subsequent combinations of the remaining cities are computed.

Upon including other travel variables (such as hotels, air, train and so on) the number of combinations grows exponentially.

### Graphical Representation

FIG. 3b is an exemplary graphical representation of the different combinations 302 described in FIG. 3a. The X-Axis of the graph represents the combination number and the Y-axis of the graph represents total flight and total cost of the trip.

Further, the graph represents the travelling cost for each of the 24 combinations. For example, for the first combination/itinerary (Madrid, Amsterdam, Paris and Venice), the cost involved is $7,687. Consequently, the best outcome, worst outcome and average outcome are identified in the graph.

The most expensive city order 304, cost is $8,677 (Paris to Venice to Madrid to Amsterdam). The least expensive city order 306, cost is $6,704 (Madrid to Amsterdam to Venice to Paris). Further, the average city order cost is $7871. As a result, the total savings from average city order cost is $1,167 (15% savings of average order).

### System Block Diagram

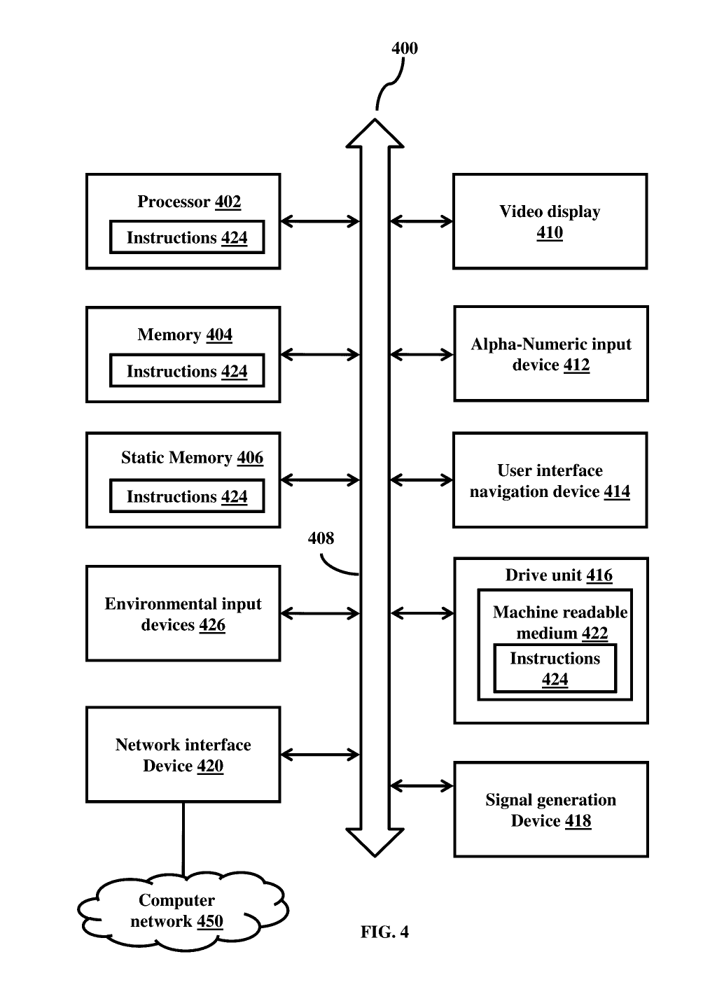

FIG. 4 is a block diagram of a machine in the example form of a computer system 400 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU), or both), a main memory 404, and a static memory 406, which communicate with each other via a bus 408. The computer system 400 may further include a video display unit 410 (e.g., a liquid crystal display (LCD) or a cathode ray tube (CRT)). The computer system 400 also includes an alphanumeric input device 412 (e.g., a keyboard), a user interface (UI) navigation device 414 (e.g., a mouse), a disk drive unit 416, a signal generation device 418(e.g., a speaker), and a network interface device 420. The computer system 400 may also include a environmental input device 426 that may provide a number of inputs describing the environment in which the computer system 400 or another device exists, including, but not limited to, any of a Global Positioning Sensing (GPS) receiver, a temperature sensor, a light sensor, a still photo or video camera, an audio sensor (e.g., a microphone), a velocity sensor, a gyroscope, an accelerometer, and a compass.

### Machine-Readable Medium

The disk drive unit 416 includes a machine-readable medium 422 on which is stored one or more sets of data structures and instructions 424 (e.g., software) embodying or utilized by any one or more of the methodologies or functions described herein. The instructions 424 may also reside, completely or at least partially, within the main memory 404 and/or within the processor 402 during execution thereof by the computer system 400, the main memory 404 and the processor 402 also constituting machine-readable media.

While the machine-readable medium 422 is shown in an example embodiment to be a single medium, the term “machine-readable medium” may include a single medium or multiple media (e.g., a centralized or distributed database, and/or associated caches and servers) that store the one or more instructions 424 or data structures. The term “non-transitory machine-readable medium” shall also be taken to include any tangible medium that is capable of storing, encoding, or carrying instructions for execution by the machine and that cause the machine to perform any one or more of the methodologies of the present subject matter, or that is capable of storing, encoding, or carrying data structures utilized by or associated with such instructions. The term “non-transitory machine-readable medium” shall accordingly be taken to include, but not be limited to, solid-state memories, and optical and magnetic media. Specific examples of non-transitory machine-readable media include, but are not limited to, non-volatile memory, including by way of example, semiconductor memory devices (e.g., Erasable Programmable Read-Only Memory (EPROM), Electrically Erasable Programmable Read-Only Memory (EEPROM), and flash memory devices), magnetic disks such as internal hard disks and removable disks, magneto-optical disks, and CD-ROM and DVD-ROM disks.

### Transmission Medium

The instructions 424 may further be transmitted or received over a computer network 450 using a transmission medium. The instructions 424 may be transmitted using the network interface device 420 and any one of a number of well-known transfer protocols (e.g., HTTP). Examples of communication networks include a local area network (LAN), a wide area network (WAN), the Internet, mobile telephone networks, Plain Old Telephone Service (POTS) networks, and wireless data networks (e.g., WiFi and WiMAX networks). The term “transmission medium” shall be taken to include any intangible medium that is capable of storing, encoding, or carrying instructions for execution by the machine, and includes digital or analog communications signals or other intangible media to facilitate communication of such software.

As described herein, computer software products can be written in any of various suitable programming languages, such as C, C++, C#, Pascal, Fortran, Perl, Matlab (from MathWorks), SAS, SPSS, JavaScript, AJAX, and Java. The computer software product can be an independent application with data input and data display modules. Alternatively, the computer software products can be classes that can be instantiated as distributed objects. The computer software products can also be component software, for example Java Beans or Enterprise Java Beans. Much functionality described herein can be implemented in computer software, computer hardware, or a combination.

Furthermore, a computer that is running the previously mentioned computer software can be connected to a network and can interface to other computers using the network. The network can be an intranet, internet, or the Internet, among others. The network can be a wired network (for example, using copper), telephone network, packet network, an optical network (for example, using optical fiber), or a wireless network, or a combination of such networks. For example, data and other information can be passed between the computer and components (or steps) of a system using a wireless network based on a protocol, for example Wi-Fi (IEEE standard 802.11 including its substandards a, b, e, g, h, i, n, et al.). In one example, signals from the computer can be transferred, at least in part, wirelessly to components or other computers.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Accordingly, the disclosure of the present invention is intended to be illustrative, but not limiting, of the scope of the invention, which is set forth in the following claims.

1. A computer-implemented method for optimizing travel specifications using mathematical combinations, the computer-implemented method comprises:
receiving a range of specifications for a desired trip from a user, the specifications comprises of number of travelers, departure city, range of dates of the trip, potential cities to visit, duration ranges of stay at each city, hotel requirements and transportation options;
calculating a plurality of mathematical combinations based on all the specifications to yield best potential itinerary options for the trip;
presenting to the user a list of the best potential itineraries along with amount saved for each itinerary option.

2. The computer-implemented method of claim 1 wherein the specifications specify variables of the trip that comprises of absolute values and sliders of ranges between the cost of the trip and convenience.

3. The computer-implemented method of claim 2 and further comprising:
receiving pricing data for the specifications.

4. The computer-implemented method of claim 1 and further comprising:
storing the pricing data in a centralized database.

5. The computer-implemented method of claim 1 wherein the mathematical combinations are created by rearranging unique discrete variables of the trip.

6. The computer-implemented method of claim 1 wherein the number of mathematical combinations increases exponentially with the number of variables.

7. The computer-implemented method of claim 1 wherein the best itinerary is calculated by taking all the mathematical combinations of the variables and presenting the lowest price to the user.

8. A computer program product stored on a non-transitory computer readable medium that when executed by a processor, performs a method for optimizing travel specifications using mathematical combinations, the computer program product comprises:
receiving a range of specifications for a desired trip from a user, the specifications comprises of number of travelers, departure city, range of dates of the trip, potential cities to visit, duration ranges of stay at each city, hotel requirements and transportation options;
calculating a plurality of mathematical combinations based on all the specifications to yield best potential itinerary options for the trip;
presenting to the user a list of the best potential itineraries along with amount saved for each itinerary option.

9. The computer program product of claim 8 wherein the specifications specify variables of the trip that comprises of absolute values and sliders of ranges between the cost of the trip and convenience.

10. The computer program product of claim 9 and further comprising:
receiving pricing data for the specifications.

11. The computer program product of claim 8 and further comprising:
storing the pricing data in a centralized database.

12. The computer program product of claim 8 wherein the mathematical combinations are created by rearranging unique discrete variables of the trip.

13. The computer program product of claim 8 wherein the number of mathematical combinations increases exponentially with the number of variables.

14. The computer program product of claim 8 wherein the best itinerary is calculated by taking all the mathematical combinations of the variables and presenting the lowest price to the user.

15. A system for optimizing travel specifications using mathematical combinations, the system comprises:
a client device operated by a user;
a centralized database to store pricing data for specifications of a trip; and
a processor coupled within the computing device and configured to perform the method of optimizing travel specifications.

16. The system of claim 15 wherein the client device further comprises:
a receiving module to receive a range of specifications for a desired trip from the user; and
a calculating module to calculating a plurality of mathematical combinations based on all the specifications to yield best potential itinerary options for the trip.

17. The system of claim 15 wherein the client device further comprises:
a user interface for presenting to the user a list of the best potential itineraries along with amount saved for each itinerary option.

18. The system of claim 15 wherein the client device further receives pricing data for the specifications.

19. The system of claim 16 wherein the specifications comprises of number of travelers, departure city, range of dates of the trip, potential cities to visit, duration ranges of stay at each city, hotel requirements and transportation options.

20. The system of claim 15 and further comprising:
a network that allows the client device to connect to Application Programming Interfaces of a plurality of travel agencies.
